(19) United States
(12) Patent Application Publication
(10) Pub. No.: US 2026/0178196 A1
(43) Pub. Date: Jun. 25, 2026

(54) MEMORY MANAGEMENT METHOD, MEMORY STORAGE DEVICE, AND MEMORY CONTROL CIRCUIT UNIT

(71) Applicant: PHISON ELECTRONICS CORP., Miaoli (TW)

(72) Inventor: Cheng-Hua Wu, Miaoli County (TW)

(73) Assignee: PHISON ELECTRONICS CORP., Miaoli (TW)

(21) Appl. No.: 19/048,979

(22) Filed: Feb. 10, 2025

(30) Foreign Application Priority Data
Dec. 25, 2024 (TW) 113150704

(51) Int. Cl. G06F 3/06

(52) U.S. Cl. CPC G06F 3/0611; G06F 3/0634; G06F 3/0659; G06F 3/0679

(57) ABSTRACT

A memory management method, a memory storage device, and a memory control circuit unit are provided. The memory management method includes: recording a random read count for each of multiple first physical units, in which each first physical unit stores valid data; initiating a data merging process; selecting multiple source physical units from the first physical units according to the random read count; and moving valid data in the source physical units to a target physical unit.

### CROSS-REFERENCE TO RELATED APPLICATION

This application claims the priority benefit of Taiwan application serial no. 113150704, filed on Dec. 25, 2024. The entirety of the above-mentioned patent application is hereby incorporated by reference herein and made a part of this specification.

### BACKGROUND

### Technical Field

The disclosure relates to a memory management method, and particularly to a method for data merging of a rewritable non-volatile memory module, a memory storage device, and a memory control circuit unit.

### Description of Related Art

The rapid growth of portable electronic devices such as mobile phones and laptops in recent years has led to a rapid increase in consumer demand for storage media. Since a rewritable non-volatile memory module (e.g., a flash memory) has the characteristics of data non-volatility, power saving, small size, and having no mechanical structure, it is very suitable for being built in a variety of portable electronic devices as exemplified above.

In the operation process of a rewritable non-volatile memory module, read behaviors are usually divided into random read and sequential read. Random read is used for non-continuous access requirements, while sequential read is suitable for large-scale and continuous data access. The performance of these two read modes directly affects the overall system performance.

Another core mechanism of rewritable non-volatile memory modules is garbage collection (GC), which aims to concentrate valid data into a certain block, releasing more storage capacity of blocks. However, garbage collection operations require data movement and block erasure, and these additional costs may conflict with normal read operations. When garbage collection and random read operations overlap, read latency will increase significantly, leading to a degraded user experience.

### SUMMARY

The disclosure proposes a memory management method, a memory storage device, and a memory control circuit unit that may reduce read latency.

The disclosure proposes a memory management method for a rewritable non-volatile memory module, and this rewritable non-volatile memory module includes multiple physical units. The memory management method includes: recording a random read count of each of a plurality of first physical units, in which each of the first physical units stores valid data; initiating a data merging process; selecting a plurality of source physical units from the first physical units according to the random read counts; and moving valid data in the source physical units to a target physical unit. A memory cell the source physical unit is configured to store P bits, a memory cell in the target physical unit is configured to store Q bits, P and Q are positive integers, and Q is greater than P.

In an embodiment of the disclosure, the random read counts of the source physical units are smaller than the random read counts of physical units that are not selected among the first physical units.

In an embodiment of the disclosure, selecting the source physical units according to the random read counts includes: setting, for each of the first physical units, a priority according to a corresponding random read count and a size of the valid data, in which the priority is negatively correlated with the random read count, and the priority is negatively correlated with a size of the valid data; and selecting the source physical units from the first physical units according to the priority.

In an embodiment of the disclosure, the memory management method further includes: determining a programming mode of the target physical unit according to the random read counts of the source physical units, in which the programming mode is a first sub-programming mode or a second sub-programming mode. In the first sub-programming mode, the memory cell in the target physical unit is configured to store Q₁ bits. In the second sub-programming mode, the memory cell in the target physical unit is configured to store Q₂ bits. Q₁ and Q₂ are positive integers, and Q₁ is less than Q₂.

In an embodiment of the disclosure, determining the programming mode of the target physical unit according to the random read counts of the source physical units includes: setting, in response to the random read counts of the source physical units being smaller than a threshold value, the programming mode of the target physical unit to the second sub-programming mode; and setting, in response to the random read counts of the source physical units being greater than or equal to the threshold value, the programming mode of the target physical unit to the first sub-programming mode.

In an embodiment of the disclosure, recording the random read count of each of the first physical units includes: receiving a plurality of read commands from a host system; and updating, in response to two consecutive read commands reading different first physical units, the random read count of the first physical unit read by the latter of the two read commands.

In an embodiment of the disclosure, recording the random read count of each of the first physical units includes: calculating, for each of the first physical units, a ratio of a corresponding number of times of random read divided by a total number of times of random read as the random read count.

From another perspective, an embodiment of the disclosure proposes a memory storage device, including: a connection interface unit, configured to couple to a host system; a rewritable non-volatile memory module, including a plurality of physical units; and a memory control circuit unit, coupled to the connection interface unit and the rewritable non-volatile memory module. The memory control circuit unit is configured to execute a plurality of steps including: recording a random read count of each of a plurality of first physical units, in which each of the first physical units stores valid data; initiating a data merging process; selecting a plurality of source physical units from the first physical units according to the random read counts; and moving valid data in the source physical units to a target physical unit. A memory cell the source physical unit is configured to store P bits, a memory cell in the target physical unit is configured to store Q bits, P and Q are positive integers, and Q is greater than P.

From another perspective, an embodiment of the disclosure proposes a memory control circuit unit for controlling a rewritable non-volatile memory module. The rewritable non-volatile memory module includes a plurality of physical units. The memory control circuit unit includes: a host interface, configured to couple to a host system; a memory interface, configured to couple to the rewritable non-volatile memory module; and a memory management circuit, coupled to the host interface and the memory interface. The memory management circuit is configured to execute a plurality of steps including: recording a random read count of each of a plurality of first physical units, in which each of the first physical units stores valid data; initiating a data merging process; selecting a plurality of source physical units from the first physical units according to the random read counts; and moving valid data in the source physical units to a target physical unit. A memory cell the source physical unit is configured to store P bits, a memory cell in the target physical unit is configured to store Q bits, P and Q are positive integers, and Q is greater than P.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a flowchart of a memory management method according to an embodiment.

FIG. 8 is a schematic diagram of the recording of random read counts according to an embodiment.

FIG. 9 is a schematic diagram of the selection of a source physical unit according to an embodiment.

FIG. 10 is a schematic diagram of the determination of a programming mode for a target physical unit according to an embodiment.

### DESCRIPTION OF THE EMBODIMENTS

Some exemplary embodiments of the disclosure will be described in detail with reference to the accompanying drawings. Element symbol referenced in the following description will be regarded as the same or similar element when the same element symbol appears in different drawings. These examples are only a portion of the disclosure and do not disclose all possible embodiments of the disclosure. More precisely, these embodiments are only examples of the system and method within the scope of the patent application of the disclosure.

Regarding the use of “first,” “second,” and the like herein, they do not specifically indicate order or sequence, but are merely used to distinguish components or operations described with the same technical terms.

In general, a memory storage device (also referred to as a memory storage system) includes a rewritable non-volatile memory module and a controller (also referred to as a control circuit). The memory storage device may be used with a host system so that the host system may write data to or read data from the memory storage device.

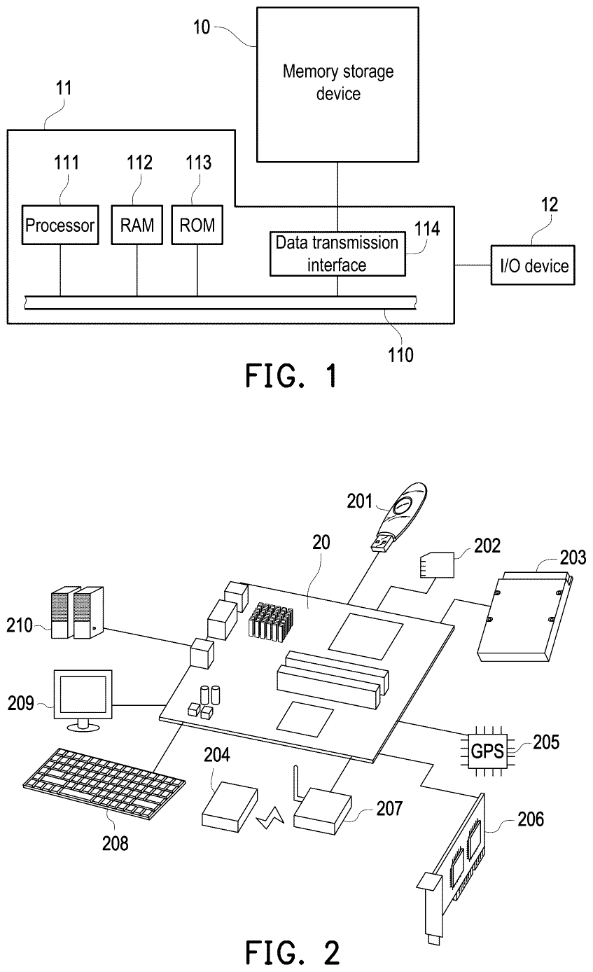

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For example, the host system 11 may store data to or read data from the memory storage device 10 via the data transmission interface 114. In addition, the host system 11 may be coupled to an I/O device 12 through the system bus 110. For example, the host system 11 may transmit output signals to or receive input signals from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. The motherboard 20 may be coupled to the memory storage device 10 through the data transmission interface 114 via a wired or wireless connection.

In an exemplary embodiment, the memory storage device 10 may be, for example, a flash drive 201, a memory card 202, a solid state drive (SSD) 203, or a wireless memory storage device 204. The wireless memory storage device 204 may be a memory storage device based on various wireless communication technologies, such as a near field communication (NFC) memory storage device, a wireless fax (WiFi) memory storage device, a Bluetooth memory storage device, a low power Bluetooth memory storage device (e.g., iBeacon), etc. In addition, the motherboard 20 may also be coupled to various I/O devices, such as a global positioning system (GPS) module 205, a network interface card 206, a wireless transmission device 207, a keyboard 208, a screen 209, a speaker 210, etc., through the system bus 110. For example, in an exemplary embodiment, the motherboard 20 may access the wireless memory storage device 204 through the wireless transmission device 207.

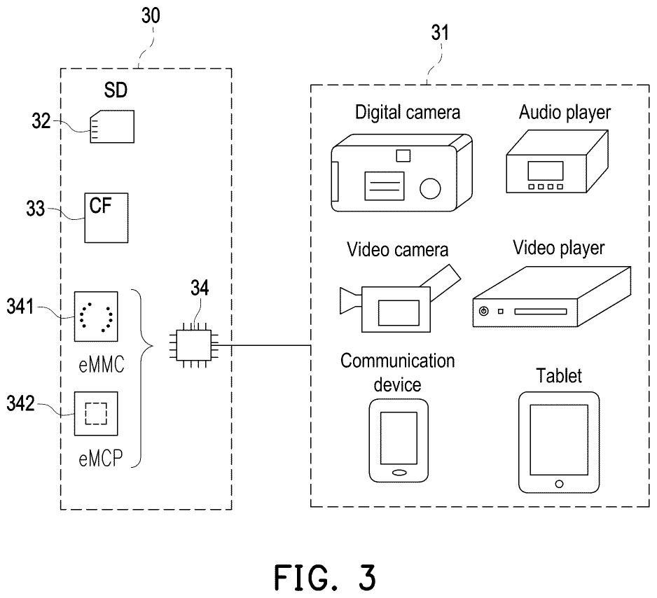

In an exemplary embodiment, the host system 11 is a computer system. In an exemplary embodiment, the host system 11 may be any system that may substantially cooperate with a memory storage device to store data. In an exemplary embodiment, the memory storage device 10 and the host system 11 may respectively include the memory storage device 30 and the host system 31 of FIG. 3.

FIG. 3 is a schematic diagram of a host system and a memory storage device according to an exemplary embodiment of the disclosure. Referring to FIG. 3, the memory storage device 30 may be used in conjunction with the host system 31 to store data. For example, the host system 31 may be a system such a digital camera, a video camera, a communication device, an audio player, a video player, or a tablet, etc. For example, the memory storage device 30 may be various non-volatile memory storage devices, such as a secure digital (SD) card 32, a compact flash (CF) card 33, or an embedded storage device 34, etc., used in the host system 31. The embedded storage device 34 includes various embedded storage devices that directly couple a memory module to a substrate of the host system, such as an embedded multimedia card (eMMC) 341 and/or an embedded multi-chip package (eMCP) storage device 342, etc.

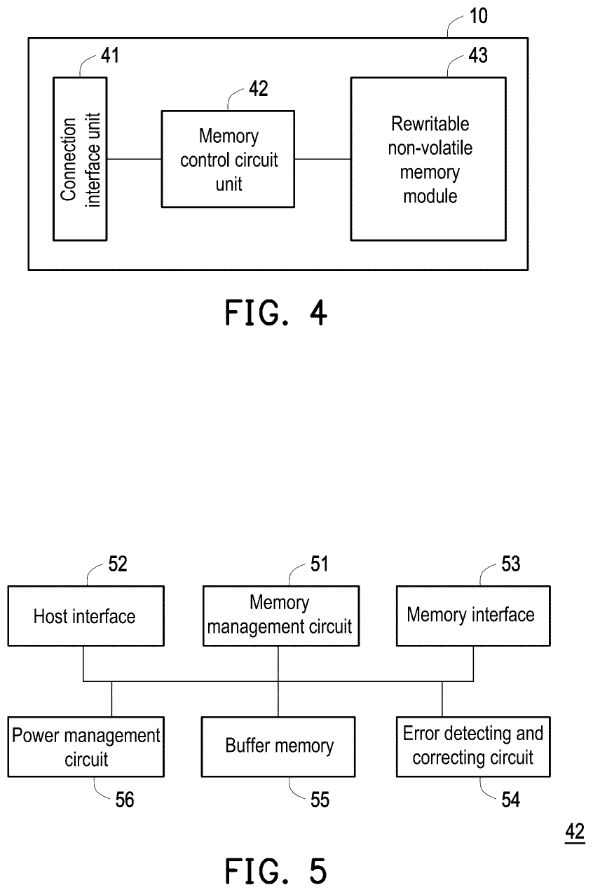

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is configured to couple to a host system 11. The memory storage device 10 may communicate with the host system 11 via the connection interface unit 41. In an exemplary embodiment, the connection interface unit 41 is compatible with the peripheral component interconnect express (PCI Express) standard. In an exemplary embodiment, the connection interface unit 41 may also be compliant to the serial advanced technology attachment (SATA) standard, the parallel advanced technology attachment (PATA) standard, the institute of electrical and electronic engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 may be packaged in a chip with the memory control circuit unit 42, or the connection interface unit 41 may be disposed outside a chip including the memory control circuit unit 42.

The memory control circuit unit 42 is coupled to the connection interface unit 41 and the rewritable non-volatile memory module 43. The memory control circuit unit 42 is configured to execute multiple logic gates or control commands implemented in a hardware form or a firmware form and to perform operations such as writing, reading, and erasing of data in the rewritable non-volatile memory module 43 according to the commands of the host system 11.

The rewritable non-volatile memory module 43 is configured to store the data written by the host system 11. The rewritable non-volatile memory module 43 may include a single level cell (SLC) NAND-type flash memory module (i.e., a flash memory that may store 1 bit in one memory cell), multi level cell (MLC) NAND-type flash memory module (i.e., a flash memory module that may store 2 bits in one memory cell), a triple level cell (TLC) NAND-type flash memory module (i.e., a flash memory module that may store 3 bits in one memory cell), a quad level cell (QLC) NAND-type flash memory module (i.e., a flash memory module that may store 4 bits in one memory cell), other flash memory modules, or other memory modules with the same characteristics.

Each memory cell in the rewritable non-volatile memory module 43 stores one or more bits by a change in a voltage (also referred to as a threshold voltage hereinafter). Specifically, there is a charge trapping layer between a control gate and a channel of each of the memory cells. By applying a write voltage to the control gate, the amount of electrons in the charge trapping layer may be changed, thereby changing the threshold voltage of the memory cell. This operation of changing the threshold voltage of the memory cell is also referred to as “writing data to the memory cell” or “programming the memory cell”. As the threshold voltage changes, each of the memory cells in the rewritable non-volatile memory module 43 has multiple storage statuses. By applying a read voltage, it is possible to determine which storage status a memory cell belongs to, thereby obtaining the one or more bits stored in the memory cell.

In an exemplary embodiment, the memory cells of the rewritable non-volatile memory module 43 may constitute multiple physical programming units, and the physical programming units may constitute multiple physical erasing units. Specifically, memory cells on the same word line may form one or more physical programming units. If each memory cell may store two or more bits, the physical programming units on the same word line may be classified at least as lower physical programming units and upper physical programming units. For example, the least significant bit (LSB) of a memory cell belongs to a lower physical programming unit, and the most significant bit (MSB) of a memory cell belongs to an upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In an exemplary embodiment, the physical programming unit is the minimum unit for programming. That is, the physical programming unit is the minimum unit for writing data. For example, the physical programming unit may be a physical page or a physical sector. If the physical programming unit is a physical page, then the physical programming unit may include a data bit area and a redundancy bit area. The data bit area includes multiple physical sectors and is used for storing user data, and the redundancy bit area is used for storing system data (e.g., management data such as error correction codes). In an exemplary embodiment, the data bit area includes 32 physical sectors, and the size of a physical sector is 512 bytes (B). However, in other exemplary embodiments, the data bit area may also include 8, 16, or a greater or lesser number of physical sectors, and the size of each of the physical sectors may also be larger or smaller. On the other hand, the physical erasing unit is the minimum unit for erasing. That is, each of the physical erasing units includes the smallest number of memory cells to be erased together. For example, the physical erasing unit is a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has multiple control commands, and when the memory storage device 10 operates, the control commands are executed to perform operations such as writing, reading, and erasing of data. The following description of the operation of the memory management circuit 51 is equivalent to the description of the operation of the memory control circuit unit 42 and the memory storage device 10.

In an exemplary embodiment, the control commands of the memory management circuit 51 are implemented in a firmware form. For example, the memory management circuit 51 has a microprocessor unit (not shown) and a read only memory (not shown), and the control commands are programmed into the read only memory. When the memory storage device 10 operates, the control commands are executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in a program code form. In addition, the memory management circuit 51 has a microprocessor unit (not shown), a read-only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. Thereafter, the microprocessor unit runs these control commands to perform operations such as writing, reading, and erasing data.

In an exemplary embodiment, the control commands of the memory management circuit 51 may also be implemented in a hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is configured to manage the memory cells or a memory cell group of the rewritable non-volatile memory module 43. The memory writing circuit is configured to issue a write command sequence to the rewritable non-volatile memory module 43 to write data into the rewritable non-volatile memory module 43. The memory reading circuit is configured to issue a read command sequence to the rewritable non-volatile memory module 43 to read data from the rewritable non-volatile memory module 43. The memory erasing circuit is configured to issue an erase command sequence to the rewritable non-volatile memory module 43 to erase data from the rewritable non-volatile memory module 43. The data processing circuit is configured to process the data to be written into the rewritable non-volatile memory module 43 and the data read from the rewritable non-volatile memory module 43. The write command sequence, the read command sequence and the erase command sequence may respectively include one or more program codes or command codes for instructing the rewritable non-volatile memory module 43 to perform corresponding writing, reading, and erasing operations. In an exemplary embodiment, the memory management circuit 51 may also issue other types of command sequences to instruct the rewritable non-volatile memory module 43 to perform corresponding operations.

The host interface 52 is coupled to the memory management circuit 51. The memory management circuit 51 may communicate with the host system 11 through the host interface 52. The host interface 52 may be configured to obtain and identify commands and data transmitted by the host system 11. For example, the commands and data transmitted by the host system 11 may be transmitted to the memory management circuit 51 through the host interface 52. In addition, the memory management circuit 51 may transmit data to the host system 11 through the host interface 52. In this exemplary embodiment, the host interface 52 is compatible with the PCI Express standard. However, it should be understood that the disclosure is not limited thereto, and the host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is configured to access the rewritable non-volatile memory module 43. For example, the memory management circuit 51 may access the rewritable non-volatile memory module 43 through the memory interface 53. In other words, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits a corresponding command sequence. For example, the command sequences may include a write command sequence to instruct data writing, a read command sequence to instruct data reading, an erase command sequence to instruct data erasing, and corresponding command sequences for instructing various memory operations (e.g., changing the read voltage level, executing a garbage collection (GC) operation, etc.). These command sequences are, for example, generated by the memory management circuit 51 and transmitted to the rewritable non-volatile memory module 43 via the memory interface 53. These command sequences may include one or more signals or data on the bus. The signals or data may include command codes or program codes. For example, the read command sequence includes information such as the read identification code, the memory address, etc.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute an error detecting and correcting operation to ensure the correctness of the data. Specifically, when the memory management circuit 51 obtains a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code to the rewritable non-volatile memory module 43. Thereafter, when the memory management circuit 51 reads data from the rewritable non-volatile memory module 43, it simultaneously reads the error correcting code and/or the error detecting code corresponding to the data, and the error detecting and correcting circuit 54 executes the error detecting and correcting operation on the read data according to the error correcting code and/or error detecting code. For example, the error detecting and correcting circuit 54 may use various encoding/decoding algorithms such as low density parity check code (LDPC code), BCH code, Reed-Solomon code (RS code), exclusive OR (XOR) code, etc., to encode and decode data.

The buffer memory 55 is coupled to the memory management circuit 51 and configured to temporarily store data. The power management circuit 56 is coupled to the memory management circuit 51 and configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

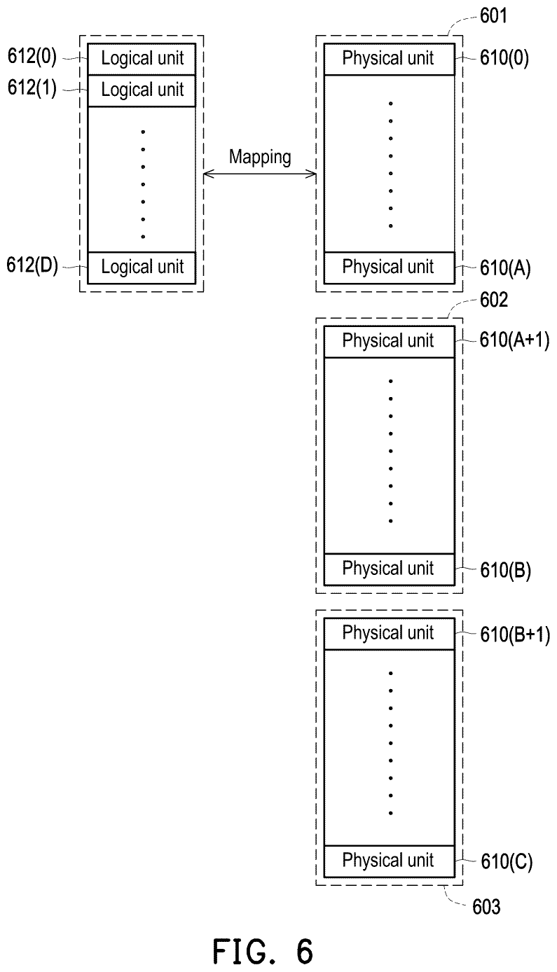

FIG. 6 is a schematic diagram of managing a rewritable non-volatile memory module according to an exemplary embodiment of the disclosure. Referring to FIG. 6, the memory management circuit 51 may logically group the physical units 610(0) to 610(C) in the rewritable non-volatile memory module 43 into a storage area 601, a spare area 602, and a system area 603.

In an exemplary embodiment, a physical unit is formed by multiple consecutive or non-consecutive physical addresses. In an exemplary embodiment, a physical unit may also refer to a virtual block (VB), where a virtual block may include one or more physical erasing units.

In an exemplary embodiment, the physical units 610(0) to 610(A) in the storage area 601 are configured to store user data (for example, user data from the host system 11 in FIG. 1). For example, the physical units 610(0) to 610(A) in the storage area 601 may store valid data and invalid data. The physical units 610(A+1) to 610(B) in the spare area 602 do not store data (e.g., valid data). For example, if a certain physical unit does not store valid data, this physical unit may be associated (or added) to the spare area 602. In addition, the physical units in the spare area 602 (or the physical units not storing valid data) may be erased. When new data is written, one or more physical units may be extracted from the spare area 602 to store the new data. In an exemplary embodiment, the spare area 602 is also referred to as a free pool.

In an exemplary embodiment, the logical units 612(0) to 612(D) may be configured in the memory management circuit 51 to map the physical units 610(0) to 610(A) in the storage area 601. In an exemplary embodiment, each of the logical units corresponds to a logical address. For example, a logical address may include one or more logical block addresses (LBA) or other logical management units. In an exemplary embodiment, a logical unit may also correspond to a logical programming unit or be formed by multiple consecutive or non-consecutive logical addresses.

It should be noted that a logical unit may be mapped to one or more physical units. If a certain physical unit is currently mapped by a certain logical unit, it means that the data currently stored in this physical unit includes valid data. On the contrary, if a certain physical unit is not currently mapped by any logical unit, it means that the data currently stored in this physical unit is invalid data.

In an exemplary embodiment, the memory management circuit 51 may record the management data (also referred to as the logical to physical mapping information) describing the mapping relationship between logical units and physical units in at least one logical to physical mapping table (L2P table). When the host system 11 reads data from the memory storage device 10 or writes data to the memory storage device 10, the memory management circuit 51 may access the rewritable non-volatile memory module 43 according to the information in the logical to physical mapping table.

In an exemplary embodiment, the memory management circuit 51 may store specific types of data in the system area 603. For example, the physical units 610(B+1) to 610(C) in the system area 603 may be dedicated to storing data of higher importance and/or data that is not intended to be accessed or modified by the host system 11. For instance, the data of higher importance and/or data not intended to be accessed or modified by the host system 11 may include the logical to physical mapping table, bad block management table, wear leveling management table, valid data management table and/or other types of management data, which are not limited by the disclosure. The logical to physical mapping table is configured to record mapping information. This mapping information may reflect the mapping relationship between logical units and physical units. The bad block management table is configured to record information related to at least one bad block in the rewritable non-volatile memory module 43. The wear leveling management table may be configured to record information related to the wear state of at least one physical unit in the rewritable non-volatile memory module 43 (e.g., read count, write count, and/or erase count). The valid data management table may be configured to record information related to the valid count of at least one physical unit in the rewritable non-volatile memory module 43, where the valid count indicates how many pieces of valid data are in the physical unit.

In an exemplary embodiment, the memory management circuit 51 may not map any logical unit to the physical units in the system area 603. In this way, it may prevent the data stored in the system area 603 from being accessed or modified by the host system 11.

In an exemplary embodiment, the physical units 610(0) to 610(C) in the rewritable non-volatile memory module 43 may include a first-type physical unit and a second-type physical unit. For example, each physical unit in the rewritable non-volatile memory module 43 may be one of the first-type physical unit and the second-type physical unit. The data access speed of each first-type physical unit is greater than the data access speed of each second-type physical unit, and/or the data capacity of each first-type physical unit is less than the data capacity of each second-type physical unit.

In an exemplary embodiment, the first-type physical unit may be regarded as a temporary storage area or a buffer area for data, and the second-type physical unit may be regarded as a storage area for data. In an exemplary embodiment, data from the host system 11 may be quickly stored in the first-type physical unit through higher writing efficiency. In response to data from the host system 11 being stored in the first-type physical unit, a write complete message may be sent back to the host system 11. Afterwards, the data stored in the first-type physical unit may be copied to the second-type physical unit with larger data capacity for storage in a background operation. Then, the used first-type physical unit may be released and erased to continuously receive (i.e., store) new data from the host system 11.

In an exemplary embodiment, the memory management circuit 51 may instruct the rewritable non-volatile memory module 43 to program the first-type physical unit based on a certain programming mode (also referred to as the first programming mode), to store data in the first-type physical unit. On the other hand, the memory management circuit 51 may instruct the rewritable non-volatile memory module 43 to program the second-type physical unit based on another programming mode (also referred to as the second programming mode), to store data in the second-type physical unit. The first programming mode is different from the second programming mode.

In an exemplary embodiment, the first programming mode is configured to store P bits in a single memory cell in the first-type physical unit, and the second programming mode is configured to store Q bits in a single memory cell in the second-type physical unit. Both P and Q are positive integers, and P is not equal to Q.

In an exemplary embodiment, P is less than Q. For example, P may be “1” and Q may be “2”, “3”, or “4”. In an exemplary embodiment, when the number of memory cells is the same, the data capacity of each first-type physical unit may be P/Q of the data capacity of each second-type physical unit. For example, assuming that P and Q are “1” and “4” respectively, the data capacity of each first-type physical unit may be ¼ of the data capacity of each second-type physical unit.

In an exemplary embodiment, the first programming mode refers to one of the SLC programming mode, the pseudo SLC programming mode, the lower physical programming mode, the mixture programming mode, and the less layer memory cell mode. In the SLC programming mode and the pseudo SLC programming mode, a memory cell only stores one bit of data. In the lower physical programming mode, only the lower physical programming unit is programmed, and the upper physical programming unit corresponding to the lower physical programming unit may not be programmed. In the mixture programming mode, valid data (or real data) is programmed in the lower physical programming unit, and at the same time dummy data is programmed to the upper physical programming unit corresponding to the lower physical programming unit that stores the valid data. In the less layer memory cell mode, a memory cell stores data of a first number of bits. For example, the first number may be set to “1”.

In an exemplary embodiment, the second programming mode includes multiple sub-programming modes, in which a memory cell may store different numbers of bits. For example, these sub-programming modes include MLC programming mode, TLC programming mode, QLC programming mode, or similar modes. Specifically, when the memory management circuit 51 writes data to a physical unit, a parameter may be added to the write command to determine the sub-programming mode, which means that the sub-programming mode of a physical unit may be dynamically decided.

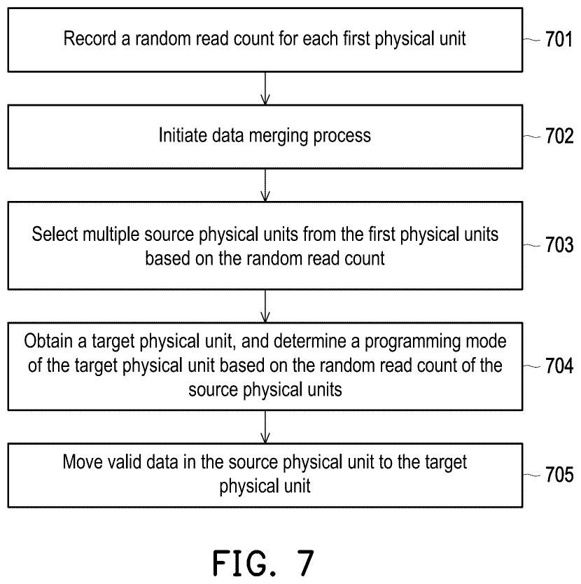

FIG. 7 is a flowchart of a memory management method according to an embodiment. Referring to FIG. 7, steps 701 to 705 are executed by the memory management circuit 51, which are not repeated hereafter. In step 701, a random read count for each of multiple first physical units are recorded, where each first physical unit stores valid data. For example, these first physical units are the aforementioned first-type physical unit, and these first physical units store data using the first programming mode (e.g., SLC programming mode).

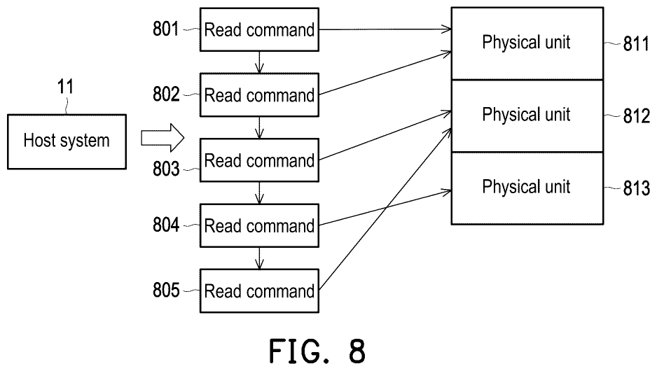

FIG. 8 is a schematic diagram of the recording of random read counts according to an embodiment. Referring to FIG. 8, it is assumed that there are 3 first physical units 811 to 813, the host system 11 issues read commands 801 to 805, each read command includes a logical address, which may be converted to a physical address according to the logical to physical mapping table, and the corresponding physical unit may be found. In this example, read command 801 is configured to read valid data in physical unit 811; read command 802 is configured to read valid data in physical unit 811; read command 803 is configured to read valid data in physical unit 812; read command 804 is configured to read valid data in physical unit 813; and read command 805 is configured to read valid data in physical unit 812.

In this example, when two consecutive read commands read valid data from the same physical unit, it is considered a sequential read; when two consecutive read commands read valid data from different physical units, it is considered a random read. Specifically, the memory management circuit 51 receives read commands 801 to 805 from the host system 11. When two consecutive read commands read different physical units 811 to 813, the random read count of the physical unit read by the latter of the two read commands is updated. For instance, read commands 801 to 802 read the same physical unit 811, so the random read count is not updated. Read commands 802 and 803 read different physical units 811 and 812 respectively, so the random read count of physical unit 812 read by read command 803 is updated. For example, by increasing the random read count, a higher random read count indicates that the valid data stored in the corresponding physical unit is randomly read with a higher frequency (or probability). The definition of random read count is further described below. Read commands 803 and 804 read different physical units 812 and 813 respectively, so the random read count of physical unit 813 read by read command 804 is updated. Read commands 804 and 805 read different physical units 813 and 812 respectively, so the random read count of physical unit 812 read by read command 805 is updated.

In some embodiments, if two consecutive read commands read different physical units, but the physical addresses to be accessed by these two read commands are consecutive, it is not considered a random read. For example, the physical address to be accessed by read command 802 is PBA, while the physical address to be accessed by read command 803 is PBA+1. Although read commands 802 and 803 read different physical units 811 and 812 respectively, since the two physical addresses to be accessed are consecutive, it is not considered a random read, and therefore the random read count of physical unit 812 is not updated. In addition, it is assumed that the physical address to be read by the read command 804 is PBA+K, where K is a positive integer greater than 2. In such an example, read commands 803 and 804 read different physical units, and the physical addresses to be accessed are not consecutive, so it is considered a random access, and thus the random read count of physical unit 813 is updated.

In some embodiments, the random read count is defined as the ratio of the number of times of random read to the total number of times of random read. Each time the random read count is updated, the number of times of random read is increased by 1. In the example of FIG. 8, the number of times of random read for physical unit 811 is 0, the number of times of random read for physical unit 812 is 2, and the number of times of random read for physical unit 813 is 1. The total number of times of random read is 2+1=3. Thus, the random read count for physical unit 811 is 0, for physical unit 812 is ⅔, and for physical unit 813 is ⅓. In this example, the valid data in physical unit 812 has a higher frequency of being randomly read, while the valid data in physical unit 813 has a lower frequency of being randomly read.

In other embodiments, the random read count may also be directly set to be the same as the number of times of random read. Alternatively, the random read count may be set as the ratio of the number of times of random read divided by the total number of reads (including both random reads and sequential reads).

When data is stored in physical units using the first programming mode, the read latency is usually lower (compared to the second programming mode). For sequential reads, due to the interleave mechanism, other operations may be performed while waiting for a physical unit to be read, which has less impact on read performance. However, when performing random reads, it is more difficult to rely on the interleave mechanism, which may prevent the read latency from being hidden within other operations. In this embodiment, data that is randomly read is kept as much as possible in physical units with the first programming mode, which may reduce read latency. Specifically, this is achieved by selecting source physical units based on the random read count during data merging operations, or by setting the programming mode of the target physical unit according to the random read count. The following describes this approach in detail.

Referring to FIG. 7, at step 702, the data merging process is initiated. The data merging process, also known as garbage collection, is configured to select source physical units and move valid data from the source physical units to target physical units, then erase the source physical units to free up this memory space. In some embodiments, it may be determined whether the number of physical units in the spare area 602 is less than a threshold value, and if so, the data merging process is initiated. However, in other embodiments, the data merging process may be initiated according to other mechanisms, and the disclosure is not limited thereto.

At step 703, multiple source physical units are selected from the aforementioned first physical units based on the random read count. As mentioned above, the first physical units store valid data using the first programming mode (e.g., SLC programming mode). When reading valid data from the first physical units, the read latency is lower. Here, first physical units with lower random read counts may be selected as source physical units. In other words, the random read counts of the source physical units are lower than the random read counts of the unselected first physical units. In this way, data that is randomly read may be kept in the first physical units that are in the first programming mode, which may reduce read latency.

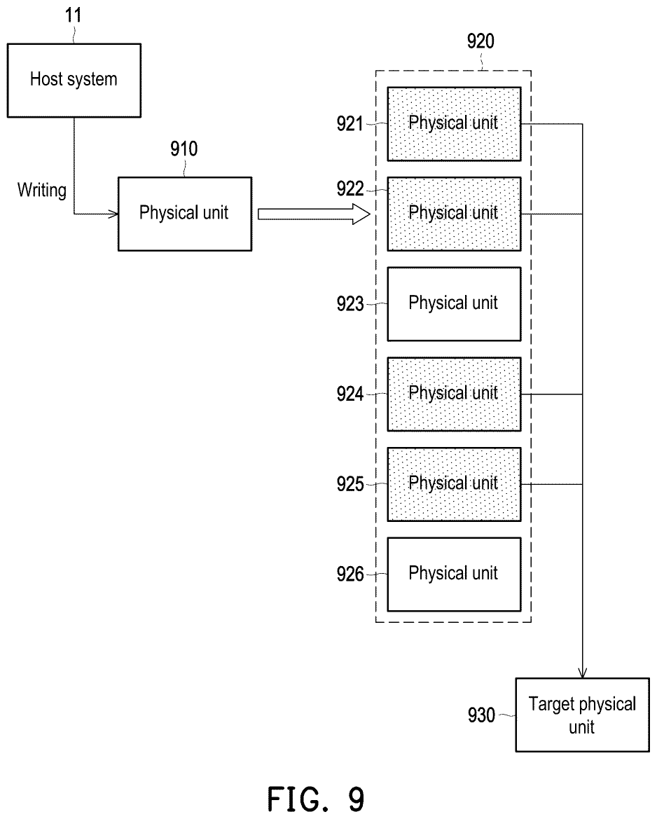

FIG. 9 is a schematic diagram of the selection of a source physical unit according to an embodiment. Referring to FIG. 9, data from the host system 11 is written to physical unit 910, which operates in the first programming mode. When physical unit 910 is filled, it is added to a set 920. When performing the data merging process, source physical units are selected from set 920. In this example, set 920 includes physical units 921 to 926, all of which store data using the first programming mode. Here, physical units 921, 922, 924, and 925 have random read counts lower than those of physical units 923 and 926. Thus, in this embodiment, physical units 921, 922, 924, and 925 are selected as source physical units.

In some embodiments, when selecting source physical units, not only the random read count is considered, but also the size of valid data (e.g., expressed as the number of physical pages). If the source physical units include less valid data, the amount of data that needs to be moved is smaller, which may quickly free up physical units. Thus, for each first physical unit, a priority may be set based on its corresponding random read count and the size of valid data, and physical units with higher priority are selected first (or have a higher probability of being selected) as source physical units. On the other hand, priority is negatively correlated with the random read count, and priority is negatively correlated with the size of valid data. In other words, when performing the data merging process, physical units with lower random read counts and less valid data are prioritized for selection as source physical units.

In some embodiments, priority may be set through process design or by calculating an indicator; the disclosure is not limited thereto. For example, physical units with lower random read counts may be selected first, and then from these, physical units with less valid data may be selected. Alternatively, physical units with less valid data may be selected first, and then from these, physical units with lower random read counts may be selected. Alternatively, the random read count and valid data size may be input into a function to calculate priority, and this function may be a linear function, polynomial function, exponential function, etc.

In step 704, a target physical unit is obtained, and the programming mode of the target physical unit is determined based on the random read count of the source physical units. The programming mode of the target physical unit is the aforementioned second programming mode. In other words, a memory cell in the source physical units is configured to store P bits, while a memory cell in the target physical unit is configured to store Q bits, where P and Q are positive integers, and Q is greater than P.

In some embodiments, the second programming mode may be further divided into multiple sub-programming modes, such as MLC, TLC, QLC, and other sub-programming modes. In this embodiment, assuming there are a first sub-programming mode and a second sub-programming mode, in the first sub-programming mode, a memory cell may store Q₁ bits, while in the second sub-programming mode, a memory cell may store Q₂ bits, where Q₁ and Q₂ are positive integers greater than 1, and Q₁ is less than Q₂. For example, Q₁=3 and Q₂=4, in this example, the first sub-programming mode is also called the TLC programming mode, while the second sub-programming mode is also called the QLC programming mode. In another embodiment, Q₁=2 and Q₂=3, in this example, the first sub-programming mode is also called the MLC programming mode, while the second sub-programming mode is also called the TLC programming mode.

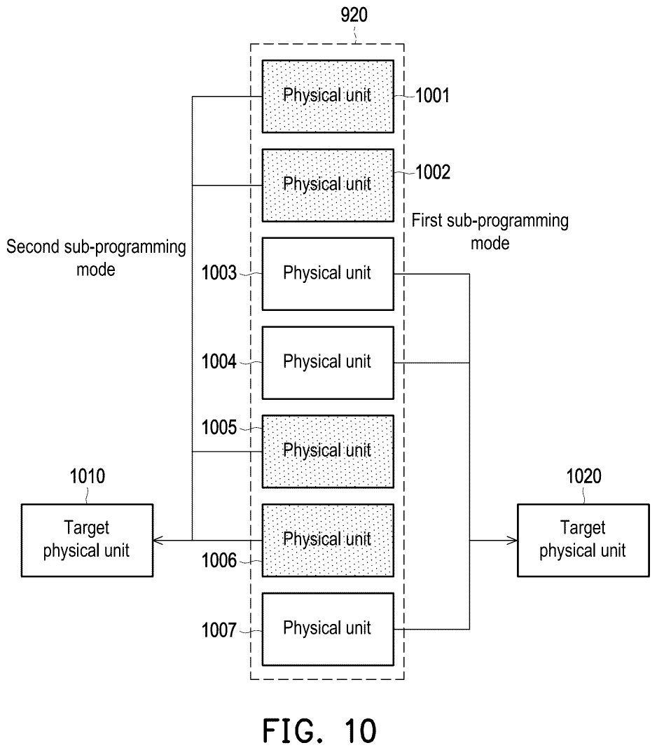

To reduce read latency, random read data may be moved to target physical units with MLC or TLC programming modes, while other data may be moved to target physical units with QLC programming mode. FIG. 10 is a schematic diagram of the determination of a programming mode for a target physical unit according to an embodiment. Referring to FIG. 10, the set 920 includes physical units 1001 to 1007, where physical units 1001, 1002, 1005, and 1006 have lower random read counts, while physical units 1003, 1004, and 1007 have higher random read counts. In some embodiments, when the random read count of the source physical unit is greater than or equal to a threshold value, the programming mode of the target physical unit is set to the first sub-programming mode; and when the random read count of the source physical unit is less than a threshold value, the programming mode of the target physical unit is set to the second sub-programming mode. For example, when the data merging process is initiated, physical units 1001, 1002, 1005, and 1006 may be selected as source physical units, and the programming mode of the target physical unit may be set to the second sub-programming mode. If there are still not enough physical units in the spare area 602, and the data merging process needs to continue, physical units 1003, 1004, and 1007 may be selected as source physical units, and since these source physical units have higher random read counts, the programming mode of the target physical unit 1020 may be set to the first sub-programming mode. In other words, each memory cell in the target physical unit 1020 stores fewer bits than each memory cell in the target physical unit 1010. As the target physical unit 1010 has a larger storage capacity, while the target physical unit 1020 has lower read latency, this approach is to balance the trade-off between space and read latency.

Referring back to FIG. 7, at step 705, the valid data in the source physical unit is moved to the target physical unit. In FIG. 9, data with no random read (or with lower degree of random read) is moved to the target physical unit 930. In FIG. 10, data with lower degree of random read is moved to the target physical unit 1010, and data with higher degree of random read is moved to the target physical unit 1020. The above approaches are all aimed at storing random read data in physical units with lower read latency as much as possible.

The steps in FIG. 7 may be implemented as multiple codes or circuits, and the disclosure is not limited thereto. Moreover, the method of FIG. 7 may be used in conjunction with the above embodiments or used independently. In other words, other steps may also be added between the steps of FIG. 7. In some embodiments, the source physical unit may be selected only based on the random read count, without setting the programming mode of the target physical unit according to the random read count. In some embodiments, conversely, the programming mode of the target physical unit may be set according to the random read count, without selecting the source physical unit based on the random read count.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A memory management method, for a rewritable non-volatile memory module, wherein the rewritable non-volatile memory module comprises a plurality of physical units, and the memory management method comprises:
recording a random read count of each of a plurality of first physical units among the physical units, wherein each of the first physical units stores valid data;
initiating a data merging process;
selecting a plurality of source physical units from the first physical units according to the random read counts; and
moving the valid data in the source physical units to a target physical unit among the physical units, wherein a memory cell in each of the source physical units is configured to store P bits, a memory cell in the target physical unit is configured to store Q bits, P and Q are positive integers, and Q is greater than P.

2. The memory management method according to claim 1, wherein the random read counts of the source physical units are smaller than the random read counts of physical units that are not selected among the first physical units.

3. The memory management method according to claim 1, wherein selecting the source physical units from the first physical units according to the random read counts comprises:
setting, for each of the first physical units, a priority according to a corresponding random read count and a size of the valid data, wherein the priority is negatively correlated with the random read count, and the priority is negatively correlated with a size of the valid data; and
selecting the source physical units from the first physical units according to the priority.

4. The memory management method according to claim 1, further comprising:
determining a programming mode of the target physical unit according to the random read counts of the source physical units, wherein the programming mode is a first sub-programming mode or a second sub-programming mode,
wherein in the first sub-programming mode, the memory cell in the target physical unit is configured to store Q₁ bits, and
wherein in the second sub-programming mode, the memory cell in the target physical unit is configured to store Q₂ bits, wherein Q₁ and Q₂ are positive integers, and Q₁ is smaller than Q₂.

5. The memory management method according to claim 4, wherein determining the programming mode of the target physical unit according to the random read counts of the source physical units comprises:
setting, in response to the random read counts of the source physical units being smaller than a threshold value, the programming mode of the target physical unit to the second sub-programming mode; and
setting, in response to the random read counts of the source physical units being greater than or equal to the threshold value, the programming mode of the target physical unit to the first sub-programming mode.

6. The memory management method according to claim 1, wherein recording the random read count of each of the first physical units among the physical units comprises:
receiving a plurality of read commands from a host system; and
updating, in response to two consecutive read commands among the read commands reading different first physical units, the random read count of the first physical unit read by the latter of the two read commands.

7. The memory management method according to claim 6, wherein recording the random read count of each of the first physical units among the physical units comprises:
calculating, for each of the first physical units, a ratio of a corresponding number of times of random read divided by a total number of times of random read as the random read count.

8. A memory storage device, comprising:
a connection interface unit, configured to couple to a host system;
a rewritable non-volatile memory module, wherein the rewritable non-volatile memory module comprises a plurality of physical units; and
a memory control circuit unit, coupled to the connection interface unit and the rewritable non-volatile memory module,
wherein the memory control circuit unit is configured to execute a plurality of steps comprising:
recording a random read count of each of a plurality of first physical units among the physical units, wherein each of the first physical units stores valid data;
initiating a data merging process;
selecting a plurality of source physical units from the first physical units according to the random read counts; and
moving the valid data in the source physical units to a target physical unit among the physical units, wherein a memory cell in each of the source physical units is configured to store P bits, a memory cell in the target physical unit is configured to store Q bits, P and Q are positive integers, and Q is greater than P.

9. The memory storage device according to claim 8, wherein the random read counts of the source physical units are smaller than the random read counts of physical units that are not selected among the first physical units.

10. The memory storage device according to claim 8, wherein selecting the source physical units from the first physical units according to the random read counts comprises:
setting, for each of the first physical units, a priority according to a corresponding random read count and a size of the valid data, wherein the priority is negatively correlated with the random read count, and the priority is negatively correlated with a size of the valid data; and
selecting the source physical units from the first physical units according to the priority.

11. The memory storage device according to claim 8, wherein the steps further comprise:
determining a programming mode of the target physical unit according to the random read counts of the source physical units, wherein the programming mode is a first sub-programming mode or a second sub-programming mode,
wherein in the first sub-programming mode, the memory cell in the target physical unit is configured to store Q₁ bits, and
wherein in the second sub-programming mode, the memory cell in the target physical unit is configured to store Q₂ bits, wherein Q₁ and Q₂ are positive integers, and Q₁ is smaller than Q₂.

12. The memory storage device according to claim 11, wherein determining the programming mode of the target physical unit according to the random read counts of the source physical units comprises:
setting, in response to the random read counts of the source physical units being smaller than a threshold value, the programming mode of the target physical unit to the second sub-programming mode; and
setting, in response to the random read counts of the source physical units being greater than or equal to the threshold value, the programming mode of the target physical unit to the first sub-programming mode.

13. The memory storage device according to claim 8, wherein recording the random read count of each of the first physical units among the physical units comprises:
receiving a plurality of read commands from the host system; and
updating, in response to two consecutive read commands among the read commands reading different first physical units, the random read count of the first physical unit read by the latter of the two read commands.

14. The memory storage device according to claim 13, wherein recording the random read count of each of the first physical units among the physical units comprises:
calculating, for each of the first physical units, a ratio of a corresponding number of times of random read divided by a total number of times of random read as the random read count.

15. A memory control circuit unit for controlling a rewritable non-volatile memory module, wherein the rewritable non-volatile memory module comprises a plurality of physical units, and the memory control circuit unit comprises:
a host interface, configured to couple to a host system;
a memory interface, configured to couple to the rewritable non-volatile memory module; and
a memory management circuit, coupled to the host interface and the memory interface,
wherein the memory management circuit is configured to execute a plurality of steps comprising:
recording a random read count of each of a plurality of first physical units among the physical units, wherein each of the first physical units stores valid data;
initiating a data merging process;
selecting a plurality of source physical units from the first physical units according to the random read counts; and
moving the valid data in the source physical units to a target physical unit among the physical units, wherein a memory cell in each of the source physical units is configured to store P bits, a memory cell in the target physical unit is configured to store Q bits, P and Q are positive integers, and Q is greater than P.

16. The memory control circuit unit according to claim 15, wherein the random read counts of the source physical units are smaller than the random read counts of physical units that are not selected among the first physical units.

17. The memory control circuit unit according to claim 15, wherein selecting the source physical units from the first physical units according to the random read counts comprises:
setting, for each of the first physical units, a priority according to a corresponding random read count and a size of the valid data, wherein the priority is negatively correlated with the random read count, and the priority is negatively correlated with a size of the valid data; and
selecting the source physical units from the first physical units according to the priority.

18. The memory control circuit unit according to claim 15, wherein the steps further comprise:
determining a programming mode of the target physical unit according to the random read counts of the source physical units, wherein the programming mode is a first sub-programming mode or a second sub-programming mode,
wherein in the first sub-programming mode, the memory cell in the target physical unit is configured to store Q₁ bits, and
wherein in the second sub-programming mode, the memory cell in the target physical unit is configured to store Q₂ bits, wherein Q₁ and Q₂ are positive integers, and Q₁ is smaller than Q₂.

19. The memory control circuit unit according to claim 18, wherein determining the programming mode of the target physical unit according to the random read counts of the source physical units comprises:
setting, in response to the random read counts of the source physical units being smaller than a threshold value, the programming mode of the target physical unit to the second sub-programming mode; and
setting, in response to the random read counts of the source physical units being greater than or equal to the threshold value, the programming mode of the target physical unit to the first sub-programming mode.

20. The memory control circuit unit according to claim 15, wherein recording the random read count of each of the first physical units among the physical units comprises:
receiving a plurality of read commands from a host system; and
updating, in response to two consecutive read commands among the read commands reading different first physical units, the random read count of the first physical unit read by the latter of the two read commands.

21. The memory control circuit unit according to claim 20, wherein recording the random read count of each of the first physical units among the physical units comprises:
calculating, for each of the first physical units, a ratio of a corresponding number of times of random read divided by a total number of times of random read as the random read count.
